(19) United States
(12) Patent Application Publication
(10) Pub. No.: US 2006/0048719 A1
(43) Pub. Date: Mar. 9, 2006

(54) Luffa dog toy

(75) Inventor: Ward Myers, Wayzata, MN (US)

Correspondence Address: WESTMAN CHAMPLIN & KELLY, P.A., SUITE 1400 - INTERNATIONAL CENTRE, 900 SECOND AVENUE SOUTH, MINNEAPOLIS, MN, 55402-3319, US

(73) Assignee: Hyper Products, Inc., Wayzata, MN (US)

(21) Appl. No.: 10/936,866

(22) Filed: Sep. 9, 2004

(51) Int. Cl. A01K 29/00

(52) U.S. Cl. 119/710

(57) ABSTRACT

The present invention includes a dog toy made from luffa. The dog toy may take various shapes, for example, the shape of a ball, a bone or other forms. Flavorant may also be added to make the chew toy more desirable to the dog.

### BACKGROUND OF THE INVENTION

The present invention relates to dog chew toys.

Dog chew toys are made from a variety of materials, both natural and synthetic. For example, dog chew toys are made of rawhide, wood or synthetic plastics. In case of the latter, care has not been taken to make chew toys from materials that are not be detrimental to the long-term health of the animal.

### SUMMARY OF THE INVENTION

The present invention includes a dog toy made from luffa. The dog toy may take various shapes, for example, the shape of a ball, a bone or other forms. Flavorant may also be added to make the chew toy more desirable to the dog.

### BRIEF DESCRIPTION OF THE DRAWINGS

FIG. 1 is a perspective view of a luffa toy of the present invention.

FIG. 2 is a perspective view of a ball made of luffa of the present invention.

FIG. 3 is a perspective view of a bone toy made of luffa.

FIG. 4 is a sectional view taken along the line 4-4 in FIG. 3.

### DETAILED DESCRIPTION OF THE PREFERRED EMBODIMENTS

The present invention includes a dog toy made of luffa material. Luffa (sometimes spelled loofa or loofah) material is obtained from what is commonly known as the sponge gourd. Most luffa comes from commonly known species luffa cylindrica or luffa aegypitca (luffa aegyptica) which are in the gourd family (cucurbitaceae).

The luffa toy of the present invention is intended not to be a consumable toy but to be a chew toy. However, depending on the type of dog and its disposition, the toy, may be eventually consumed. However, since it is made of a natural material, there are no long term health consequences to the dog.

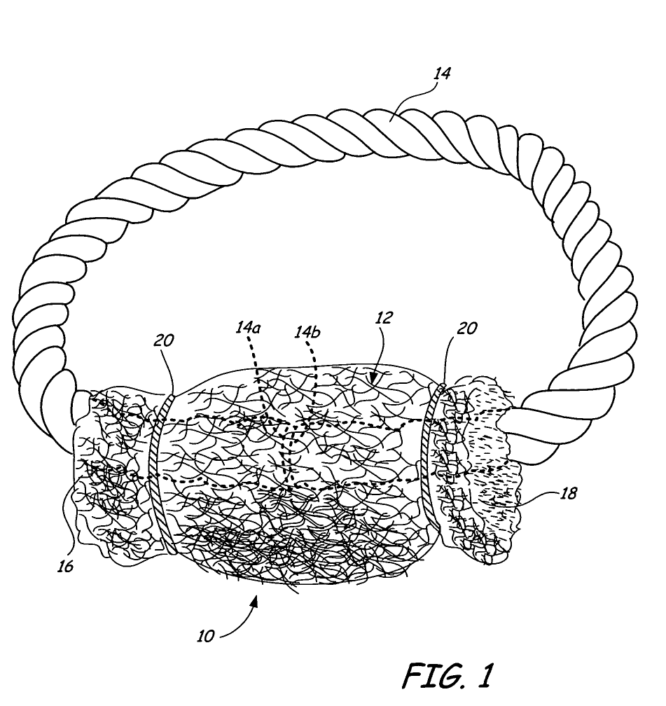

Luffa material is taken from a mature luffa sponge gourd in which the outer skin has been removed. The dry luffa material is then shaped and formed to a chewable dog toy. The process of making the luffa dog toy depends on the selected shape of the toy. For example, as illustrated in FIG. 1 the luffa toy 10 is in the form of a rope toy. The toy 10 includes a luffa portion 12 and a rope 14 extending in a continuous loop through opposite ends 16 and 18 of the luffa portion 12. To make the toy 10, the rope 14 is made into a continuous loop by joining ends 14a and 14b together by any suitable method such as stitching, tape, glue and the like. The luffa portion 12 is formed around the rope 14 by cutting a suitable piece of luffa and pressing the luffa portion into a substantially cylindrical shape.

The luffa portion 12 is secured to the rope by surrounding the luffa with a cord 20 and tightening the cord 20 such that the luffa is secured to the rope portion 14. The cord 20 squeezes the luffa such that annular impressions are made within the luffa. To further enhance the visual impression of the toy 10, the luffa material is colored with a natural colorant.

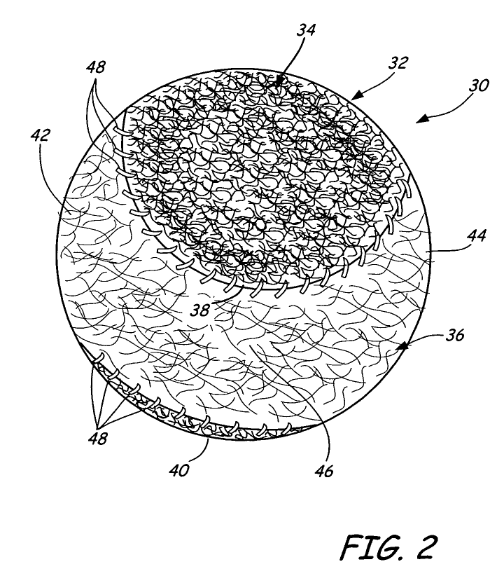

The toy 10 of the present invention can also be made in the form of a spherical ball 30 as illustrated in FIG. 2. The ball 30 is constructed similar to a baseball in that the ball 30 has a core (not illustrated) made of luffa pressed into a spherical form, and a cover 32 made of two sections 34 and 36. Each section 34 and 36 includes two lobe portions connected by a neck portion and which are similar in shape to leather coverings on a baseball. As illustrated, the section 34 includes lobe portions 38 and 40 connected by a neck section (not illustrated). The portion 36 includes lobe portion 42 and 44 connected by a neck section 46. Similar to the attachment of a leather cover to a baseball, the lobe portions 34 and 40 are positioned on opposing sides of the neck section 46 of the portion 36. Similarly, the lobe portions 42 and 44 are positioned on opposing sides of the neck portion (not illustrated) of the section 34. In this manner, the sections 34 and 36 cover the entire spherical surface of the core (not illustrated). The cover sections 34 and 36 are then stitched (in a fashion similar to a baseball) using a cord 48 to secure the edges of the sections 34 and 36 to each other and to the core (not illustrated) of the ball. To further enhance the visual impression of the ball, one section such as 34, may be dyed with a color using a natural dye with section 36 being left naturally colored or bleached blonde.

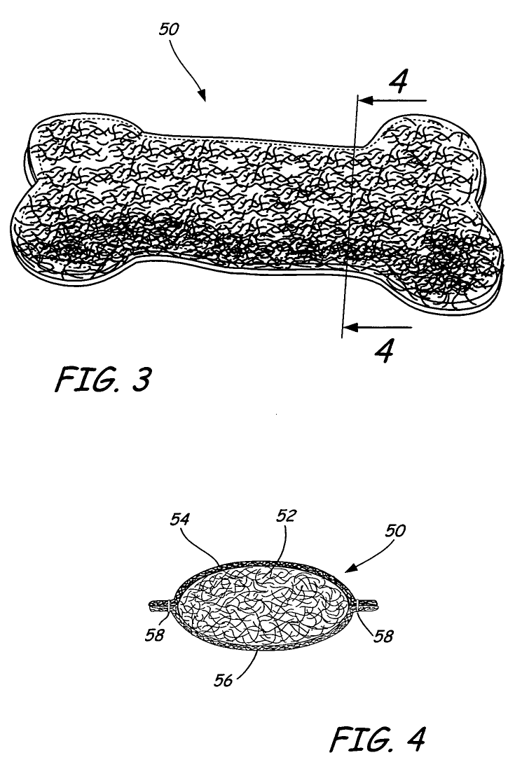

Another form of the luffa toy is illustrated at 50 in FIGS. 3 and 4. Toy 50 is made of three parts, including a core section 52 and cover sections 54 and 56. The core section 52 which forms the spine of the bone toy 50 is cut and pressed into its longitudinal form 50. The cover sections 54 and 56 are then also cut in the shape of a bone and pressed to fit around the core 52. The cover sections 54 and 56 are stitched using suitable twine 58 along their edges. To further enhance the visual impression of the bone toy, one section may be dyed of a color using a natural dye while the other section is left naturally or bleached blonde.

To further the desirability of the toys of the present invention to a dog, a flavorant may be injected within the core sections of the toys described above. One such flavorant used in a caramel flavorant but any flavorant that is desirable to dogs is within the scope of the present invention.

Although the present invention has been described with reference to preferred embodiments, workers skilled in the art will recognize that changes may be made in form and detail without departing from the spirit and scope of the invention.

1. A dog toy comprising:
luffa.

2. The toy of claim 1 and further comprising a core section and a cover section, the cover section covering the core, and both cover and core sections being made of luffa.

3. The toy of claim 2 wherein the core section includes a flavorant.

4. The toy of claim 2 wherein the cover section is attached to the core by stitching.

5. The dog toy of claim 1 wherein the toy is in the shape of a ball.

6. The toy of claim 1 wherein the toy is in the shape of a bone.

7. The toy of claim 1 wherein the luffa material is substantially cylindrical in shape and has opposite ends; and
a rope secured within the luffa at opposite ends thereby forming a loop.

8. The toy of claim 1 wherein the luffa material is substantially cylindrical in shape and has opposite ends; and
a rope extending through the luffa material and projecting from the opposing ends of the cylindrical shape.
